(19) United States
(12) Patent Application Publication
(10) Pub. No.: US 2025/0362521 A1
(43) Pub. Date: Nov. 27, 2025

(54) LIGHT GUIDE ELEMENT AND DISPLAY APPARATUS

(71) Applicant: CANON KABUSHIKI KAISHA, Tokyo (JP)

(72) Inventor: Yuuki MAEDA, Tochigi (JP)

(21) Appl. No.: 19/185,746

(22) Filed: Apr. 22, 2025

(30) Foreign Application Priority Data
May 21, 2024 (JP) 2024-082361

(51) Int. Cl. G02B 27/14; G02B 27/01; G02B 27/28

(52) U.S. Cl. CPC G02B 27/145; G02B 27/0101; G02B 27/283; G02B 2027/0114

(57) ABSTRACT

A light guide element is configured to guide light from a display element to a pupil and includes an entrance portion which the light is to enter, a separating portion configured to separate the light in a first direction, and an emitting portion configured to emit the light toward the pupil. The separating portion has a plurality of separating surfaces with spectral reflectances different from each other. The plurality of separating surfaces include a dielectric film including a plurality of layers.

### BACKGROUND

### Technical Field

The present disclosure relates to a light guide element and an (image) display apparatus.

### Description of Related Art

Japanese Patent Application Laid-Open No. 2024-37843 discloses an image display apparatus including a light guide plate configured to guide a displayed image to the observer's pupil.

In the image display apparatus disclosed in Japanese Patent Application Laid-Open No. 2024-37843, the light utilization efficiency decreases due to a large amount of unnecessary light.

### SUMMARY

One aspect of the present disclosure provides a light guide element configured to guide light from a display element to a pupil. The light guide element includes an entrance portion which the light is to enter, a separating portion configured to separate the light in a first direction, and an emitting portion configured to emit the light toward the pupil. The separating portion has a plurality of separating surfaces with spectral reflectances different from each other. The plurality of separating surfaces include a dielectric film including a plurality of layers. A display apparatus having the above light guide element also constitutes another aspect of the present disclosure.

Another aspect of the present disclosure provides a light guide element configured to guide light from a display element to a pupil. The light guide element includes an entrance portion which the light is to enter, a separating portion configured to separate the light in a first direction, and an emitting portion configured to emit the light toward the pupil. The separating portion has a plurality of separating surfaces with spectral reflectances different from each other. The plurality of separating surfaces includes at least one separating surface that satisfies the following inequality:

$$0.7 \leq Re ( α , n , P ) / Re ( α , n , S ) \leq 1.6$$

where regarding an n-th separating surface counted from the entrance portion among the plurality of separating surfaces, Re(α, n, S) is a reflectance [%] to S-polarized light in light with a dominant wavelength while a is an incident angle [°] of a principal ray, and Re(α, n, P) is a reflectance [%] to P-polarized light in light with a dominant wavelength while α is an incident angle [°] of a principal ray. A display apparatus having the above light guide element also constitutes another aspect of the present disclosure.

Another aspect of the present disclosure provides a display apparatus that includes a display element, and a light guide element configured to guide light from a display element to a pupil. The light guide element includes an entrance portion which the light is to enter, a separating portion configured to separate the light in a first direction, and an emitting portion configured to emit the light toward the pupil. The following inequality is satisfied:

$$Ly / Li \geq 0.40$$

where Li is an illuminance [lx] of light of a dominant wavelength incident on the entrance portion, and Ly is a light amount [lx] emitted to a region of an exit pupil in the first direction.

Further features of various embodiments of the disclosure will become apparent from the following description of embodiments with reference to the attached drawings.

### BRIEF DESCRIPTION OF THE DRAWINGS

FIG. 1 is a configuration diagram of an image display apparatus according to Example 1.

FIG. 2 is a configuration diagram of a light guide plate according to Example 1.

FIG. 3 is a configuration diagram of the light guide plate according to Example 1.

FIG. 4 is a configuration diagram of a light source unit according to Example 1.

FIGS. 5A and 5B are configuration diagrams of a light source unit according to Example 1.

FIG. 6 is a configuration diagram of a light guide plate according to Example 2.

FIG. 7 is a configuration diagram of a light guide plate according to Example 3.

FIG. 8 illustrates the reflectance to S-polarized light of first to third emitting surfaces in Example 1.

### DETAILED DESCRIPTION

Referring now to the accompanying drawings, a detailed description will be given of embodiments according to the disclosure. Corresponding elements in respective figures will be designated by the same reference numerals, and a duplicate description thereof will be omitted.

### Example 1

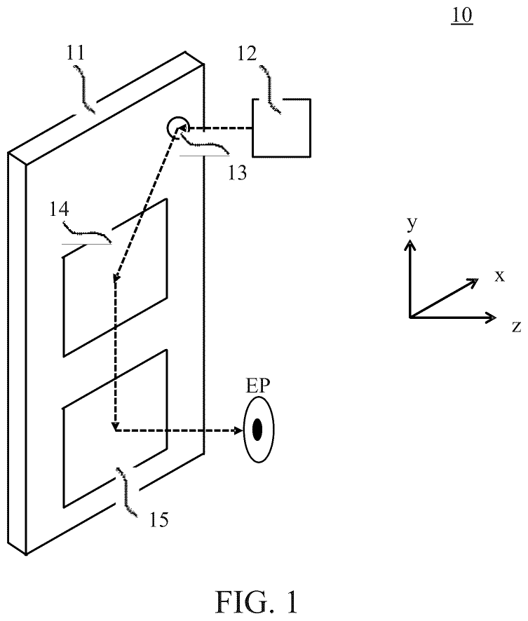

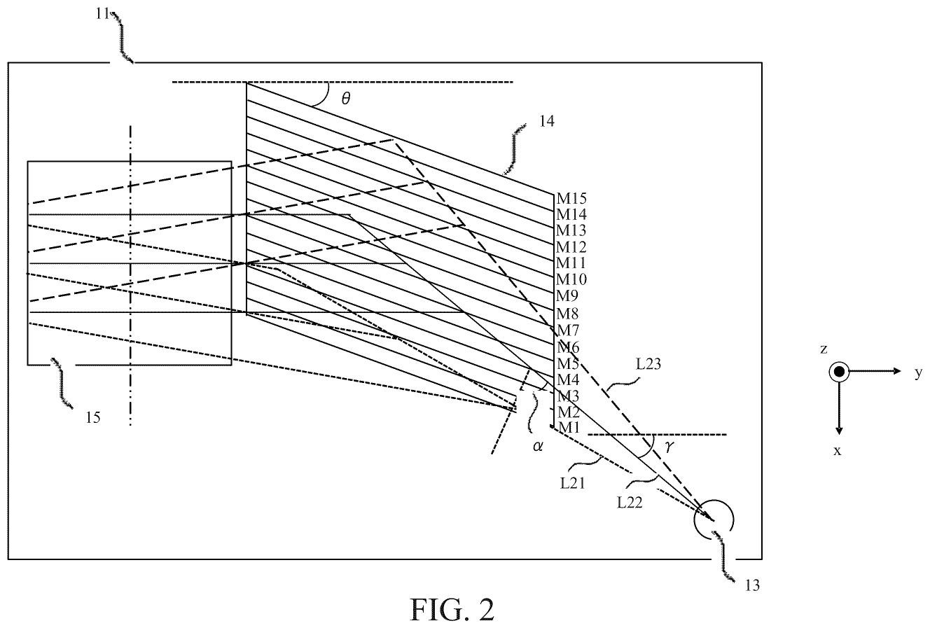

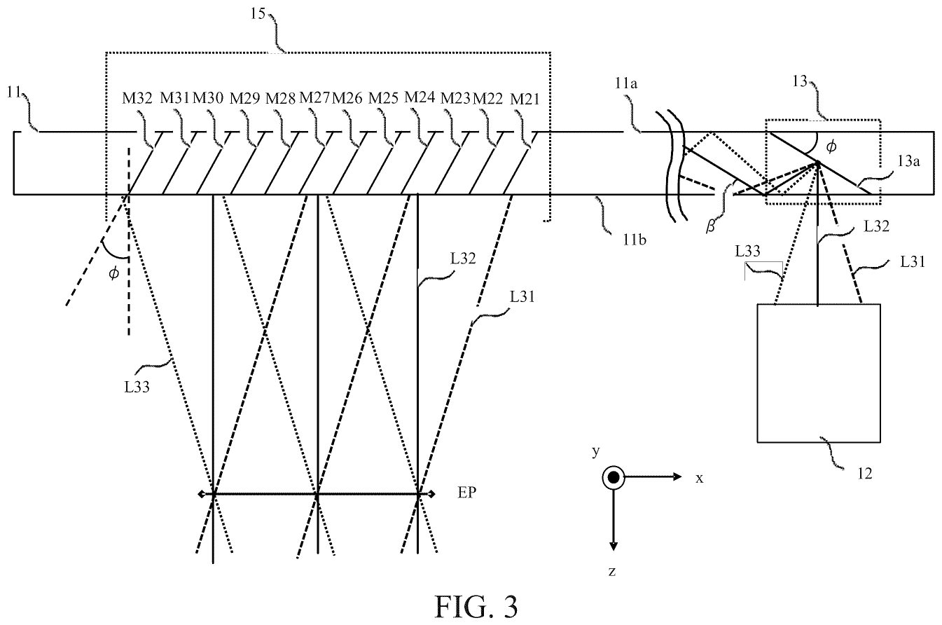

Referring now to FIGS. 1 to 3, a description will be given of an image display apparatus 10 and a light guide plate (light guide element) 11 according to Example 1 according to the present disclosure. FIG. 1 is a configuration diagram of the image display apparatus 10. FIG. 2 is a configuration diagram of the light guide plate 11 in an xy section. FIG. 3 is a configuration diagram of the light guide plate 11 in an xz section.

The image display apparatus 10 includes the light guide plate 11 and a light source unit 12. The light guide plate 11 is made of a transparent material such as glass or plastic, and guides image light from a liquid crystal panel (image display element) 44 of the light source unit 12 to a pupil EP. The light guide plate 11 has a first surface 11a and a second surface 11b that are parallel to each other. The light guide plate 11 also has an entrance portion 13, a separating portion (separator or splitter) 14 having a plurality of separating surfaces tilted at a predetermined angle (angle θ) relative to the y-axis in the xy section, and an emitting portion 15 having a plurality of separating surfaces (emitting surfaces) tilted at a predetermined angle (angle φ) in the xz section.

The image light enters the entrance portion 13. The separating portion 14 separates the image light in the pupil EP in a first direction (y(-axis) direction). The separating portion 14 has a plurality of separating surfaces with different spectral reflectances (different from each other). The emitting portion 15 emits the image light from the light guide plate 11 to the pupil EP.

The light guide plate 11 according to this example is made of a glass material with a refractive index, for example, of 1.518, but is not limited to this implementation. The plurality of separating surfaces have a characteristic of reflecting light at a predetermined angle (angle α) with a predetermined reflectance, and include a plurality of layers (a plurality of dielectric films, i.e., a dielectric film consisting of a plurality of (two or more) layers) including a high refractive index film and a low refractive index film. Generally, film materials such as TiO₂, Ta₂O₅, and ZnS are used as the high refractive index film, and film materials such as SiO₂, MgF2, and Al₂O₃ are used as the low refractive index film. In order to improve the transmittance of the outside world, an antireflection film is vapor-deposited on each of the first surface 11a and the second surface 11b.

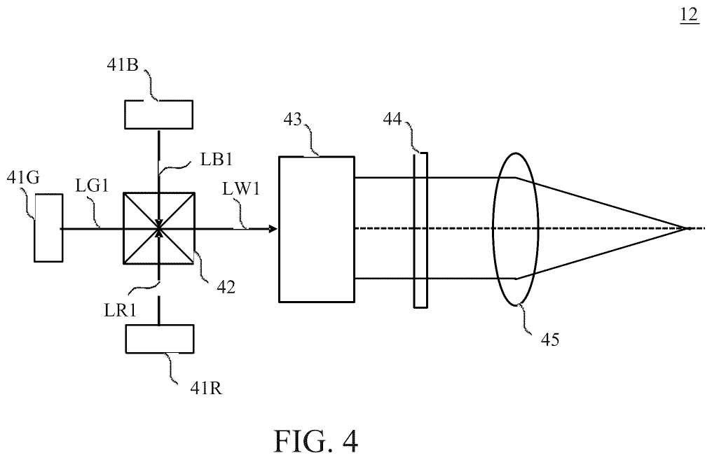

Next, the light source unit 12 will be described with reference to FIG. 4. FIG. 4 is a configuration diagram of the light source unit 12. The light source unit 12 includes an RGB laser light source 41 (41R, 41G, 41B), a cross dichroic prism 42, an illumination optical system 43, a liquid crystal panel (image display element) 44, and a condenser lens 45. The RGB laser light (P-polarized light) emitted from the laser light source 41 is combined by the cross dichroic prism 42 and emitted to the illumination optical system 43. The laser light incident on the illumination optical system 43 uniformly illuminates the liquid crystal panel 44. The image light (S-polarized light) modulated by the liquid crystal panel 44 is condensed on a predetermined position of the light guide plate 11 via the condenser lens 45. The light (P-polarized light) that is not modulated by the liquid crystal panel 44 is absorbed by a polarizing plate (not illustrated) or the like.

The P-polarized light and the S-polarized light correspond to the polarization directions defined by the separating surface (emitting surface) of the emitting portion 15 in the light guide plate 11. In this example, the laser light source 41B has a wavelength of 450 nm, the laser light source 41G has a wavelength of 520 nm, and the laser light source 41R has a wavelength of 640 nm. The dominant wavelength of the laser light source 41 is 520 nm, which has a high relative visibility. The image display apparatus 10 according to this example is configured to emit three colors of light, RGB, but is not limited to this implementation, and may be configured to emit monochromatic light using only the laser light source 41G.

In this example, instead of the liquid crystal panel 44, a reflection type liquid crystal panel (LCOS) or a digital mirror device in which micromirrors form pixels may be used as the image display element. The light source unit 12 may be configured using a laser light source and Micro Electro Mechanical Systems (MEMS). Alternatively, an Organic Light Emitting Diode (OLED) or a MicroLED may be used as the light source unit 12.

The image light polarized in a predetermined direction (S-polarized) emitted from the light source unit 12 enters the entrance portion 13 of the light guide plate 11, is deflected in a predetermined direction by the reflective surface 13a, and is totally reflected by each of the first surface 11a and the second surface 11b to propagate through the light guide plate 11. The image light is then divided into a plurality of light beams in the xy section by the separating portion 14 (an eye box (exit pupil) in the y direction of the observer's pupil EP is enlarged) and guided to the emitting portion 15.

In this example, an angle of the image light incident on the reflective surface 13a of the entrance portion 13 is assumed to be ±10° (angle within the glass). In FIG. 2, a light ray L22 represents a principal ray in the xy section, a light ray L21 represents a light ray at +10° relative to the principal ray, a light ray L23 represents a light ray at −10° relative to the principal ray, and an angle γ of the light ray L22 relative to the y-axis is 40° (y=40°). In FIG. 3, a light ray L32 represents the principal ray in the xz section, a light ray L31 represents a light ray at +10° relative to the principal ray, and a light ray L33 represents a light ray at −10° relative to the principal ray. The separating portion 14 includes a plurality of separating surfaces (fifteen separating surfaces) tilted at an angle θ. A plurality of dielectric films M1 to M15 are respectively formed on the plurality of separating surfaces. In this example, θ=20°. However, in this example, the number of dielectric films (separating surfaces) is not limited to fifteen, and may be another number.

The image light guided to the emitting portion 15 is divided into a plurality of light beams in the xz section (the eye box in the second direction (x(-axis) direction) of observer's pupil EP is enlarged) and guided to observer's pupil EP. The emitting portion 15 includes a plurality of (twelve) separating surfaces (emitting surfaces) tilted at a predetermined angle φ. The emitting portion 15 has a plurality of emitting surfaces with spectral reflectances different from each other. A plurality of dielectric films M21 to M32 are formed on the plurality of emitting surfaces. In this example, φ=30°. However, in this example, the number of dielectric films (emitting surfaces) is not limited to twelve and may be another number. The incident angles of the light rays L31, L32, and L33 reflected by the reflective surface 13a of the entrance portion 13 in the xz section relative to the second surface 11b of the light guide plate 11 are 70°, 60°, and 50°, respectively. The entrance portion 13 may include a diffractive element, a metasurface, a holographic element, or the like.

Numerical example 1 illustrates the reflectance (%) of S-polarized light and P-polarized light for an incident angle of a film at wavelengths of 450 nm, 520 nm, and 640 nm for the dielectric films M1 to M15 of the separating portion 14. An arbitrary reflectance can be used in the blank. In this example, the dielectric films M1 to M15 are designed to have approximately the same reflectance for the S-polarized light and the P-polarized light. Since the light rays L21 to L23 propagate while being totally reflected, it is important to note that an incident angle (°) in the xy section of the dielectric film does not coincide with an incident angle (°) of the dielectric film. For example, in a case where the light ray L32 (principal ray in the xz section) enters the xy section of the dielectric film at incident angles of 60°, 70°, and 80°, the incident angles of the dielectric film are 64.3°, 72.8°, and 81.4°, respectively.

The reason why the reflectances of the S-polarized light and the P-polarized light are equal to each other will now be described. A light beam from the entrance portion 13 propagates through the light guide plate 11 while being totally reflected by the first surface 11a and the second surface 11b. Therefore, a relationship between the P-polarized light and the S-polarized light in the separating portion 14 changes depending on whether the light enters the dielectric film from the first surface la or the second surface 11b, and the light incident on the separating surface of the emitting portion 15 may be S-polarized light. In a case where the reflectance to the P-polarized light is significantly lower than that to the S-polarized light, an image light amount emitted from the separating portion 14 decreases. On the other hand, in a case where the reflectance to the P-polarized light is significantly higher than that to the S-polarized light, a P-polarized light amount as an unnecessary light amount, increases in the image light emitted from the separating portion 14, and unnecessary light such as ghosts increases.

The light ray L21 (at an incident angle on the film of 64.3°) is separated (split) into a plurality of light rays by the first to fifth dielectric films M1 to M5. Similarly, the light ray L22 (at an incident angle on the film of 72.8°) is separated into a plurality of light rays by the sixth to tenth dielectric films M6 to M10, and the light ray L23 (at an incident angle of the film of 81.4°) is separated into a plurality of light rays by the eleventh to fifteenth dielectric films M11 to M15. The plurality of separated light rays are guided to the emitting portion 15 and then to the pupil EP. Since the light beam in the y direction of the pupil EP can be condensed, high light utilization efficiency can be achieved. For the incident angle on the film of 72.8°, the light intensity distribution in the y direction in the pupil EP can be uniform by increasing the reflectance from the sixth dielectric film M6 to the tenth dielectric film M10.

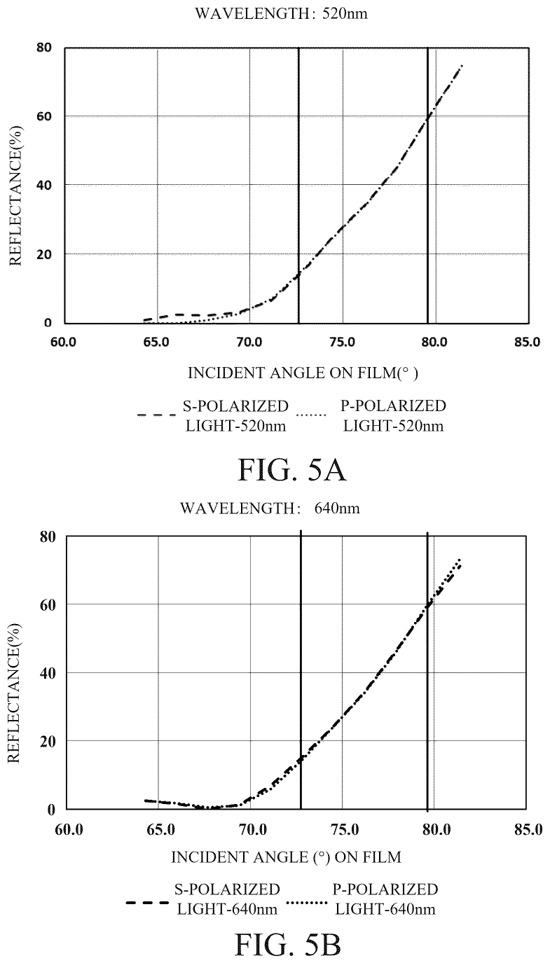

FIGS. 5A and 5B illustrate a design example of the dielectric film M6. The dielectric film M6 is an alternating film of high refractive index TiO₂ films and low refractive index SiO₂ films, with 34 film layers. The overall film thickness of the SiO₂ is 1250 nm, and the overall film thickness of the TiO₂ is 1190 nm. At a dominant wavelength of 520 nm for the green (G) light and a dominant wavelength of 640 nm for the red (R) light, the reflectance to the S-polarized light and the reflectance to the P-polarized light at the incident angles on the film of 72.8° to 79.6° are approximately the same, and are tilted at a predetermined reflectance. The blue (B) light with a dominant wavelength of 450 nm also exhibits similar characteristics. The other dielectric films also include alternating films of high refractive index TiO₂ films and low refractive index SiO₂ films.

The image light (S-polarized light) emitted from the separating portion 14 is totally reflected and propagates through the light guide plate 11, then divided into a plurality of light beams by the emitting portion 15 and guided to the observer's pupil EP. The emitting portion 15 includes twenty-first to thirty-second dielectric films M21 to M32. Similarly to the separating portion 14, the dielectric films M21 to M32 include alternating films of high refractive index TiO₂ and low refractive index SiO₂. Numerical example 2 illustrates the reflectance (%) of the S-polarized light against the incident angle of the dielectric films M21 to M32 of the separating portion 14 at dominant wavelengths of 450 nm, 520 nm, and 640 nm. A blank cell represents an arbitrary reflectance.

The first light ray L31 (at an incident angle of 70°) is separated into a plurality of light rays by the twenty-second to twenty-sixth dielectric films M21 to M26, and guided to the pupil EP. The second light ray L32 (at an incident angle of 60°) passes through the twenty-first to twenty-third dielectric films M21 to M23, is separated into a plurality of light rays by the twenty-fourth to thirtieth dielectric films M24 to M30, and is guided to the pupil EP. The third light ray L33 (at an incident angle of 50°) passes through the twenty-first to twenty-sixth dielectric films M21 to M26, is separated into a plurality of light rays by the twenty-seventh to thirty-second dielectric films M27 to M32, and is guided to the pupil EP. Therefore, the light beam can be condensed on the pupil EP, and high light utilization efficiency can be achieved.

Now assume that ωV is a field angle [°] in the first direction (y direction, vertical direction) at the pupil EP, and ωH is a field angle [°] in the second direction (x direction, horizontal direction). The position of the pupil EP is the position of the eye relief and is generally located 10 mm to 30 mm apart from the emitting portion of the light guide plate 11. In this example, the eye relief is 20 mm. In a case where the eye relief value is specified in the specifications, the value in the specifications can be used.

This example places a mask with an opening of 2 mm×2 mm at the position of the eye relief (20 mm in this example), and a range into which all light rays with a field angle ωV in the first direction are incident is defined as the size of the eye box in the first direction. Similarly, a range into which all light rays with a field angle ωH in the second direction are incident is defined as the size of the eye box in the second direction. In a case where the eye box value is specified in the specifications, the value in the specifications can be used.

A description will now be given of the conditions in this example.

An angle θ (absolute value) (°) of the separating portion 14 relative to the y direction may satisfy the following inequality (1):

$$5 \leq θ \leq 35 \qquad ( 1 )$$

In a case where θ becomes lower than the lower limit of inequality (1), the dielectric film becomes approximately parallel to the y-axis, and it becomes difficult to separate the light rays. On the other hand, in a case where θ becomes higher than the upper limit of inequality (1), an angular difference in the yz section becomes significantly expressed as a difference in the incident angle on the film, and it becomes difficult to obtain the desired performance.

Inequality (1) may be replaced with inequality (1a) below:

$$7 \leq θ \leq 30 \qquad ( 1 a )$$

Inequality (1) may be replaced with inequality (1b) below:

$$10 \leq θ \leq 25 \qquad ( 1 b )$$

The following inequalities (2) may be satisfied:

$$n H \geq 2.00 n L \leq 1.60 \qquad ( 2 )$$

where nH is a refractive index of the dielectric film with the highest refractive index and nL is a refractive index of the dielectric film with the lowest refractive index for light with a dominant wavelength. In other words, nH is a maximum value of refractive indices of the plurality of separating surfaces for the light of the dominant wavelength, and nL is a minimum value of the refractive indices of the plurality of separating surfaces for the light of the dominant wavelength.

For the desired performance, a refractive index difference between the refractive index of the high refractive index film and the refractive index of the low refractive index film may be provided.

Inequality (2) may be replaced with inequality (2a) below:

$$n H \geq 2.10 n L \leq 1.55 \qquad ( 2 a )$$

Inequality (2) may be replaced with inequality (2b) below:

$$n H \geq 2.20 n L \leq 1.50 \qquad ( 2 b )$$

The separating portion 14 has a first separating surface (M3), a second separating surface (M8), and a third separating surface (M13) as a plurality of separating surfaces. However, in this example, the first to third separating surfaces are not limited to the dielectric films M3, M8, and M13, and may be arbitrary dielectric films in the order of proximity to the entrance portion 13.

Among the plurality of separating surfaces, an n-th (n=1, 2, 3) separating surface is an n-th separating surface counted from the entrance portion 13.

The plurality of separating surfaces may include at least one of a separating surface having a refractive index for light of a dominant wavelength of 2.0 or more and a thickness of the dielectric film (Hn) of 100 nm or more, and a separating surface having a refractive index for light of a dominant wavelength of 1.6 or less and a thickness of the dielectric film (Ln) of 100 nm or more.

$$Hn \geq 100 L n \geq 100 \qquad ( 3 )$$

For the desired performance, a plurality of layers of high refractive index films and low refractive index films with a predetermined thickness or more may be used. This example may satisfy the following inequality (4):

$$H 2 \geq 1 \; 00 L 2 \geq 100 \qquad ( 4 )$$

Inequalities (4) may be replaced with inequalities (4a) below:

$$H 2 \geq 400 L 2 \geq 400 \qquad ( 4 a )$$

Inequalities (4) may be replaced with inequalities (4b) below:

$$H 2 \geq 700 L 2 \geq 7400 \qquad ( 4 b )$$

This example may satisfy the following inequalities (5) and (6):

$$\begin{matrix}H 1 \geq 100 \\ L 1 \geq 100\end{matrix} \qquad ( 5 )$$

$$\begin{matrix}H 3 \geq 100 \\ L 3 \geq 100\end{matrix} \qquad ( 6 )$$

Inequalities (5) and (6) may be replaced with inequalities (5a) and (6a) below:

$$\begin{matrix}L 1 \geq 400 \\ H 3 \geq 400\end{matrix} \qquad ( 5 a )$$

$$\begin{matrix}H 3 \geq 400 \\ L 3 \geq 400\end{matrix} \qquad ( 6 a )$$

Inequalities (5) and (6) may be replaced with inequalities (5b) and (6b) below:

$$\begin{matrix}H 1 \geq 700 \\ L 1 \geq 700\end{matrix} \qquad ( 5 b )$$

$$\begin{matrix}H 3 \geq 700 \\ L 3 \geq 700\end{matrix} \qquad ( 6 b )$$

For the desired performance, the number of film layers of the second separating surface (M8) may be 10 or more, 15 or more, or 20 or more.

The plurality of separating surfaces may include at least one separating surface that satisfies the following inequality (7):

$$0.7 \leq Re ( α , n , P ) / Re ( α , n , S ) \leq 1.6 \qquad ( 7 )$$

where regarding an n-th separating surface counted from the entrance portion among the plurality of separating surfaces, Re(α, n, S) is a reflectance [%] to S-polarized light in light with a dominant wavelength while α is an incident angle [°] of a principal ray, and Re(α, n, P) is a reflectance [%] to P-polarized light in light with a dominant wavelength while α is an incident angle [°] of a principal ray.

In a case where Re(α, n, P)/Re(α, n, S) becomes lower than the lower limit of inequality (7), a light amount decreases. On the other hand, in a case where the Re(α, n, P)/Re(α, n, S) becomes higher than the upper limit of inequality (7), unnecessary light such as ghosts increases.

This example may satisfy the following inequality (8):

$$0.7 \leq Re ( α , 2 , P ) / Re ( α , 2 , S ) \leq 1.6 \qquad ( 8 )$$

Inequality (8) may be replaced with inequality (8a) below:

$$0.8 \leq Re ( α , 2 , P ) / Re ( α , 2 , S ) \leq 1.4 \qquad ( 8 a )$$

Inequality (8) may be replaced with inequality (8b) below:

$$0.9 \leq Re ( α , 2 , P ) / Re ( α , 2 , S ) \leq 1.2 \qquad ( 8 b )$$

This example may satisfy at least one of the following inequalities (9) and (10):

$$0.7 \leq Re ( α , 1 P ) / Re ( α , 1 , S ) \leq 1.6 \qquad ( 9 )$$

$$0.7 \leq Re ( α , 3 , P ) / Re ( α , 3 , S ) \leq 1.6 \qquad ( 10 )$$

Inequalities (9) and (10) may be replaced with inequalities (9a) and (10a) below:

$$0.8 \leq Re ( α , 1 , P ) / Re ( α , 1 , S ) \leq 1.4 \qquad ( 9 a )$$

$$0.8 \leq Re ( α , 3 , P ) / Re ( α , 3 , S ) \leq 1.4 \qquad ( 10 a )$$

Inequalities (9) and (10) may be replaced with inequalities (9b) and (10b) below:

$$0.9 \leq Re ( α , 1 , P ) / Re ( α , 1 , S ) \leq 1.2 \qquad ( 9 b )$$

$$0.8 \leq Re ( α , 3 , P ) / Re ( α , 3 , S ) \leq 1.2 \qquad ( 10 b )$$

The emitting portion 15 has a first emitting surface (M23), a second emitting surface (M26), and a third emitting surface (M30) as the plurality of emitting surfaces. However, in this example, the first to third emitting surfaces are not limited to the dielectric films M23, M26, and M30, and may be arbitrary dielectric films in order of proximity to the entrance portion 13. Assume that among the plurality of emitting surfaces, the m-th (m=1, 2, 3) emitting surface from the entrance portion 13 is an m-th emitting surface. The plurality of emitting surfaces may include at least one emitting surface that satisfies the following inequality (11):

$$Ro ( β , m , P ) / Ro ( β , m , S ) \leq 0.3 \qquad ( 11 )$$

where β is an incident angle [°] of the principal ray on the m-th emitting surface, Ro(β, m, S) is a reflectance [%] of the S-polarized light on the m-th emitting surface for light of the dominant wavelength, and Ro(β, m, P) is a reflectance [%] of the P-polarized light on the m-th emitting surface.

In a case where the value becomes higher than the upper limit of inequality (11), the transmittance of the outside world decreases, and it becomes difficult to achieve the desired quality.

This example may satisfy the following inequality (12):

$$Ro ( β , 2 , P ) / Ro ( β , 2 , S ) \leq 0.3 \qquad ( 12 )$$

Inequality (12) may be replaced with inequality (12a) below:

$$Ro ( β , 2 , P ) / Ro ( β , 2 , S ) \leq 0.2 \qquad ( 12 a )$$

Inequality (12) may be replaced with inequality (12b) below:

$$Ro ( β , 2 , P ) / Ro ( β , 2 , S ) \leq 0.1 \qquad ( 12 b )$$

This example may satisfy at least one of the following inequalities (13) and (14):

$$Ro ( β , 1 , P ) / Ro ( β , 1 , S ) \leq 0.3 \qquad ( 13 )$$

$$Ro ( β , 3 , P ) / Ro ( β , 3 , S ) \leq 0.3 \qquad ( 14 )$$

Inequalities (13) and (14) may be replaced with inequalities (13a) and (14a) below:

$$Ro ( β , 1 , P ) / Ro ( β , 1 , S ) \leq 0.2 \qquad ( 13 a )$$

$$Ro ( β , 3 , P ) / Ro ( β , 3 , S ) \leq 0.2 \qquad ( 14 a )$$

Inequalities (13) and (14) may be replaced with inequalities (13b) and (14b) below:

$$Ro ( β , 1 , P ) / Ro ( β , 1 , S ) \leq 0.1 \qquad ( 13 b )$$

$$Ro ( β , 3 , P ) / Ro ( β , 3 , S ) \leq 0.1 \qquad ( 14 b )$$

Assume that nG is a refractive index of the light guide element, and ωV is a field angle (°) on a section that has the first direction. Then, a first separating surface may satisfy the following inequality:

$$Re ( α + ω V / nG , 1 , P ) > 1.1 \times Re ( α , 1 , P ) \qquad ( 15 )$$

Moreover, the plurality of separating surfaces may include at least one separating surface that satisfies the following inequality:

$$Re ( α , n , P ) > 1.1 \times Re ( α - ω V / nG , n , P ) \qquad ( 16 )$$

In a case where inequalities (15) and (16) are not satisfied, it becomes difficult to condense the image light on the desired eye box or to maintain the light utilization efficiency.

This example may satisfy the following inequality (17):

$$Re ( α + ω V / nG , 1 , P ) > 1.1 \times Re ( α , 1 , P ) \qquad ( 17 )$$

Inequality (17) may be replaced with inequality (17a) below:

$$Re ( α + ω V / nG , 1 , P ) > 1.5 \times Re ( α , 1 , P ) \qquad ( 17 a )$$

Inequality (17) may be replaced with inequality (17b) below:

$$Re ( α + ω V / nG , 1 , P ) > 2. \times Re ( α , 1 , P ) \qquad ( 17 b )$$

This example may satisfy the following inequality (18):

$$Re ( α , 2 , P ) > 1.1 \times Re ( α - ω V / nG , 2 , P ) \qquad ( 18 )$$

Inequality (18) may be replaced with inequality (18a) below:

$$Re ( α , 2 , P ) > 1.5 \times Re ( α - ω V / nG , 2 , P ) \qquad ( 18 a )$$

Inequality (18) may be replaced with inequality (18b) below:

$$Re ( α , 2 , P ) > 2. \times Re ( α - ω V / nG , 2 , P ) \qquad ( 18 b )$$

In this example, the field angle of the pupil EP may be 30° or higher. The light condensing effect in this example is particularly effective in an image display apparatus with a large field angle where the light utilization efficiency is significantly reduced. The field angle may be 35° or more or 40° or more.

The following inequality (19) may be satisfied:

$$LVH / LVL \leq 2.5 \qquad ( 19 )$$

where LVH is a maximum value of the average illuminance, and LVL is a minimum value of the average illuminance in a case where the distribution of the illuminance [lx] of the eye box is divided into five equal parts in the y direction.

In a case where inequality (19) is not satisfied, the illuminance is significantly uneven, and it becomes difficult to obtain the desired image quality.

Inequality (19) may be replaced with inequality (19a) below:

$$LVH / LVL \leq 2. \qquad ( 19 a )$$

Inequality (19) may be replaced with inequality (19b) below:

$$LVH / LVL \leq 1.6 \qquad ( 19 b )$$

The following inequality (20) may be satisfied:

$$Ly / Li \geq 0.4 \qquad ( 20 )$$

where Li is an illuminance [lx] of the dominant wavelength incident on the entrance portion 13, and Ly [lx] is an illuminance emitted to a region of an eye box in the y direction (the width in the x direction is not defined).

In a case where inequality (20) is not satisfied, it becomes difficult to acquire the desired light utilization efficiency and the image display apparatus displays a dark image.

Inequality (20) may be replaced with inequality (20a) below:

$$Ly / Li \geq 0.5 \qquad ( 20 a )$$

Inequality (20) may be replaced with inequality (20b) below:

$$Ly / Li \geq 0.60 \qquad ( 20 b )$$

The following inequality (21) may be satisfied:

$$\vert Ly 1 - Ly 2 \vert / ( Ly 1 + Ly 2 ) \geq 0.5 \qquad ( 21 )$$

where Ly1 [lx] is an illuminance of the polarized light in the first direction (P-polarized light) emitted to the region of the eye box (exit pupil) in the y direction (the width in the x direction is not defined), and Ly2 [lx] is an illuminance of the polarized light in the second direction (S-polarized light).

In a case where inequality (21) is not satisfied, unnecessary light such as ghosts increases.

Inequality (21) may be replaced with inequality (21a) below:

$$\vert Ly 1 - Ly 2 \vert / ( Ly 1 + Ly 2 ) \geq 0.65 \qquad ( 21 a )$$

Inequality (21) may be replaced with inequality (21b) below:

$$\vert Ly 1 - Ly 2 \vert / ( Ly 1 + Ly 2 ) \geq 0.80 \qquad ( 21 b )$$

The light source unit 12 emits image light of RGB visible light. Assume that a peak wavelength in the wavelength range of 500 nm to 580 nm (red band) is a first wavelength, a peak wavelength in the wavelength range of 590 nm to 670 nm (green band) is a second wavelength, and a peak wavelength in the wavelength range of 430 nm to 490 nm (blue band) is a third wavelength. Moreover, assume that Ei1 is a light amount [W/mm²] of the first wavelength incident on the entrance portion 13, Ei2 is a light amount of the second wavelength incident on the entrance portion 13, and Ei3 is a light amount of the third wavelength incident on the entrance portion 13. Ey1 is a light amount of the first wavelength emitted to the region of the eye box (exit pupil) in the y direction, Ey2 is a light amount of the second wavelength emitted to the region of the eye box in the y direction, and Ey3 is a light amount of the third wavelength emitted to the region of the eye box in the y direction. Then, the following inequalities (22) to (24) may be satisfied:

$$Ey 1 / Ei 1 \geq 0.4 \qquad ( 22 )$$

$$Ey 2 / Ei 2 \geq 0.40 \qquad ( 23 )$$

$$Ey 3 / Ei 3 \geq 0.40 \qquad ( 24 )$$

Inequalities (22) to (24) may be replaced with inequalities (22a) to (24a) below:

$$Ey 1 / Ei 1 \geq 0.5 \qquad ( 22 a )$$

$$Ey 2 / Ei 2 \geq 0.50 \qquad ( 23 a )$$

$$Ey 3 / Ei 3 \geq 0.50 \qquad ( 24 a )$$

Inequalities (22) to (24) may be replaced with inequalities (22b) to (24b) below:

$$Ey 1 / Ei 1 \geq 0.6 \qquad ( 22 b )$$

$$Ey 2 / Ei 2 \geq 0.60 \qquad ( 23 b )$$

$$Ey 3 / Ei 3 \geq 0.60 \qquad ( 24 b )$$

The following inequality (25) may be satisfied:

$$Lx / Li \geq 0.40 \qquad ( 25 )$$

where Lx is an illuminance [lx] emitted to the region of the eye box in the x direction (the width in the y direction is not defined).

In a case where inequality (25) is not satisfied, it becomes difficult to obtain the desired light utilization efficiency, and the image display apparatus displays a dark image.

Inequality (25) may be replaced with inequality (25a) below:

$$Lx / Li \geq 0.50 \qquad ( 25 a )$$

Inequality (25) may be replaced with inequality (25b) below:

$$Lx / Li \geq 0.60 \qquad ( 25 b )$$

The following inequalities (26) to (28) may be satisfied:

$$Ex 1 / Ei 1 \geq 0.4 \qquad ( 26 )$$

$$Ex 2 / Ei 2 \geq 0.40 \qquad ( 27 )$$

$$Ex 3 / Ei 3 \geq 0.40 \qquad ( 28 )$$

where Ex1 is a light amount of the first wavelength [W/mm²] emitted to the region of the eye box in the x direction, Ex2 is a light amount of the second wavelength [W/mm²] emitted to the region of the eye box in the x direction, and Ex3 is a light amount of the third wavelength [W/mm²] emitted to the region of the eye box in the x direction.

Inequalities (26) to (28) may be replaced with inequalities (26a) to (28a) below:

$$Ex 1 / Ei 1 \geq 0.5 \qquad ( 26 a )$$

$$Ex 2 / Ei 2 \geq 0.50 \qquad ( 27 a )$$

$$Ex 3 / Ei 3 \geq 0.50 \qquad ( 28 a )$$

Inequalities (26) to (28) may be replaced with inequalities (26b) to (28b) below:

$$Ex 1 / Ei 1 \geq 0.6 \qquad ( 26 b )$$

$$Ex 2 / Ei 2 \geq 0.60 \qquad ( 27 b )$$

$$Ex 3 / Ei 3 \geq 0.60 \qquad ( 28 b )$$

The following inequality (29) may be satisfied:

$$R min / R max \leq 0.20 \qquad ( 29 )$$

where Rmax is a maximum reflectance of an average of a reflectance to the P-polarized light and a reflectance to the S-polarized light of the separating portion 14 in the principal ray of the dominant wavelength, and Rmin is a minimum reflectance of the average of the reflectance to the P-polarized light and the reflectance to the S-polarized light of the separating portion 14 in the principal ray of the dominant wavelength.

Inequality (29) may be replaced with inequality (29a) below:

$$R min / R max \leq 0.15 \qquad ( 29 a )$$

Inequality (29) may be replaced with inequality (29b) below:

$$Rmin / Rmax \leq 0.10 \qquad ( 29 b )$$

In this example, the plurality of separating surfaces include at least one separating surface that satisfies the following inequalities (30) and (31):

$$Re ( α , n , P ) \leq 10. \qquad ( 30 )$$

$$Re ( α , n , S ) \leq 10. \qquad ( 31 )$$

In a case where inequalities (30) and (31) are not satisfied, unnecessary light that illuminates an area outside the eye box increases.

The first separating surface (M3) may satisfy the following inequalities (32) and (33):

$$Re ( α , 1 , P ) \leq 10. \qquad ( 32 )$$

$$Re ( α , 1 , S ) \leq 10.0 \qquad ( 33 )$$

Inequalities (32) and (33) may be replaced with inequalities (32a) and (33a) below:

$$Re ( α , 1 , P ) \leq 7. \qquad ( 32 a )$$

$$Re ( α , 1 , S ) \leq 7.0 \qquad ( 33 a )$$

Inequalities (32) and (33) may be replaced with inequalities (32b) and (33b) below:

$$Re ( α , 1 , P ) \leq 4. \qquad ( 32 b )$$

$$Re ( α , 1 , S ) \leq 4.0 \qquad ( 33 b )$$

In designing a dielectric film, the following inequality (34) may be satisfied:

$$0. < W / R < 0.03 \qquad ( 34 )$$

where R is a central wavelength [nm] of at least one spectrum of a light beam emitted from the light source, and W is a full width at half maximum (FWHM) [nm] of the spectrum.

In this example, the central wavelength R is 450 nm, 520 nm, or 640 nm, which are the dominant wavelengths of the laser light source 41. In a case where the value becomes higher than the upper limit of inequality (34), a predetermined reflectance is to be achieved over a wide wavelength range, a film design becomes difficult, light utilization efficiency decreases, and uneven brightness increases.

Inequality (34) may be replaced with inequality (34a) below:

$$0. < W / R < 0.02 \qquad ( 34 a )$$

Inequality (34) may be replaced with inequality (34b) below:

$$0. < W / R < 0.015 \qquad ( 34 b )$$

In this example, the emitting portion 15 may be configured as follows.

For example, in FIG. 3, assume that light rays with incident angles θ₁, θ₂, and θ₃ (θ₁+5<θ₂<θ₃−5) on the first surface 32a are respectively a first light ray L31, a second light ray L32, and a third light ray L33. Where φ is an angle [°] of each separating surface relative to the normal to the first surface 11a (second surface 11b), an incident angle φ1ₙ [°] of a q-th light ray (q: natural number) from the first surface 11a to the separating surface (emitting surface) is 90−θ_{q}+φ. An incident angle φ2_{q} [°] of the q-th light ray from the second surface 11b to the separating surface (emitting surface) is 90−θ_{q}−φ. For example, the angle φ is 30°, the incident angles θ₁, θ₂, and θ₃ are 50°, 60°, and 70°, respectively, and the angles of incidence φ1₁, φ1₂, φ1₃, φ2₁, φ2₂, and φ2₃ are 70°, 60°, 50°, 10°, 0°, and −10°, respectively. The second light ray L32 is the center of the light beam propagating within the light guide plate 11.

The first light ray L31 is separated into a plurality of light rays, for example, by the twenty-first to twenty-seventh dielectric films M21 to M27, and is guided to the pupil EP. The second light ray L32 passes through the twenty-first to twenty-third dielectric films M21 to M23, is separated into a plurality of light rays by the twenty-fourth to thirtieth dielectric films M24 to M30, and is guided to the pupil EP. The third light ray L33 passes through the twenty-first to twenty-sixth dielectric films M21 to M26, is separated into a plurality of light rays by the twenty-seventh to thirty-third dielectric films M27 to M32, and is guided to the pupil EP. Therefore, the light beam can be condensed on the pupil EP, and high light utilization efficiency can be achieved.

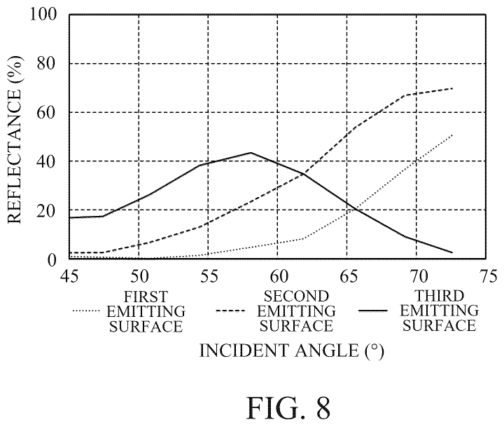

The twenty-fourth dielectric film M24 is a first emitting surface, the twenty-seventh dielectric film M27 is a second emitting surface, and the thirtieth dielectric film M30 is a third emitting surface. Each of the first, second, and third surfaces is not parallel to the first direction. Where d (mm) is an eye box size, a surface that passes through or is closest to the normal from the center of the eye box is the second emitting surface. A surface that passes through or is closest to the normal from the position d/2 in the negative x direction from the center of the eye box is the first emitting surface, and a surface that passes through or is closest to the normal from the position d/2 in the positive x direction from the center of the eye box is the third emitting surface. FIG. 8 illustrates the reflectance to the S-polarized light against the incident angle of the light of the dominant wavelength of the first to third emitting surfaces. Assume that p (p: 1, 2, 3) is an order of each of the first emitting surface, the second emitting surface, and the third emitting surface, φₚ is an angle [°] of a p-th emitting surface relative to a normal to the first surface, θ_{q} is an incident angle [°] of a q-th light ray (where q is a natural number) incident on the first surface, and Rs1_{pq} is a reflectance (%) of the p-th emitting surface relative to light of a dominant wavelength having an incident angle [°] of 90−θ_{q}+φₚ. Then, the first to third emitting surfaces may satisfy the following inequalities (35) to (37):

$$Rs {1}_{21} > Rs {1}_{22} > Rs {1}_{23} \qquad ( 35 )$$

$$Rs {1}_{31} < Rs {1}_{32} \qquad ( 36 )$$

$$Rs {1}_{33} < Rs {1}_{32} \qquad ( 37 )$$

In a case where inequality (35) is not satisfied, luminance unevenness significantly occurs, and in a case where inequalities (36) and (37) are not satisfied, the transmittance of outside world light increases.

Inequalities (35) to (37) may be replaced with inequalities (35a) to (37a) below:

$$Rs {1}_{21} > 1.2 \times Rs {1}_{22} > 1.2 \times Rs {1}_{23} \qquad ( 35 a )$$

$$1.2 \times Rs {1}_{31} < Rs {1}_{32} \qquad ( 36 a )$$

$$1.2 \times Rs {1}_{33} < Rs {1}_{32} \qquad ( 37 a )$$

Inequalities (35) to (37) may be replaced with inequalities (35b) to (37b) below:

$$Rs {1}_{21} > 1.4 \times Rs {1}_{22} > 1.4 \times Rs {1}_{23} \qquad ( 35 b )$$

$$1.4 \times Rs {1}_{31} < Rs {1}_{32} \qquad ( 36 b )$$

$$1.4 \times Rs {1}_{33} < Rs {1}_{32} \qquad ( 37 b )$$

Since the twenty-first to thirty-third dielectric films M21 to M33 have film properties that combine the properties of a polarization separation film and a half-mirror film, the refractive index nG of the substrate may be low in order for polarization separation at an incident angle ω12 of 60°. More specifically, the following inequality (38) may be satisfied:

$$n G \leq 1.70 \qquad ( 38 )$$

In a case where nG becomes higher than the upper limit of inequality (38), the Brewster condition cannot be satisfied and the transmittance of outside world light will decrease significantly.

Inequality (38) may be replaced with the following inequality (38a):

$$n G \leq 1.65 \qquad ( 38 a )$$

Inequality (38) may be replaced with the following inequality (38b):

$$n G \leq 1.60 \qquad ( 38 b )$$

Numerical examples 3 and 4 are variations of the separating portion 14 of this example. Numerical example 3 is a numerical example in which the number of types of dielectric films is reduced from 15 to 8. Numerical example 4 is a numerical example in which the illuminance distribution is more uniform. Numerical example 3 illustrates a configuration in which the same dielectric film is disposed on every two separating surfaces, but this is not limited to this implementation, and the same dielectric film may be disposed on every three or four separating surfaces.

This example illustrates a configuration in which a dielectric film is formed on the separating surface between the separating portion 14 and the emitting portion 15, but the configuration may use a fine structure such as a metasurface, a holographic element, or the like.

### Example 2

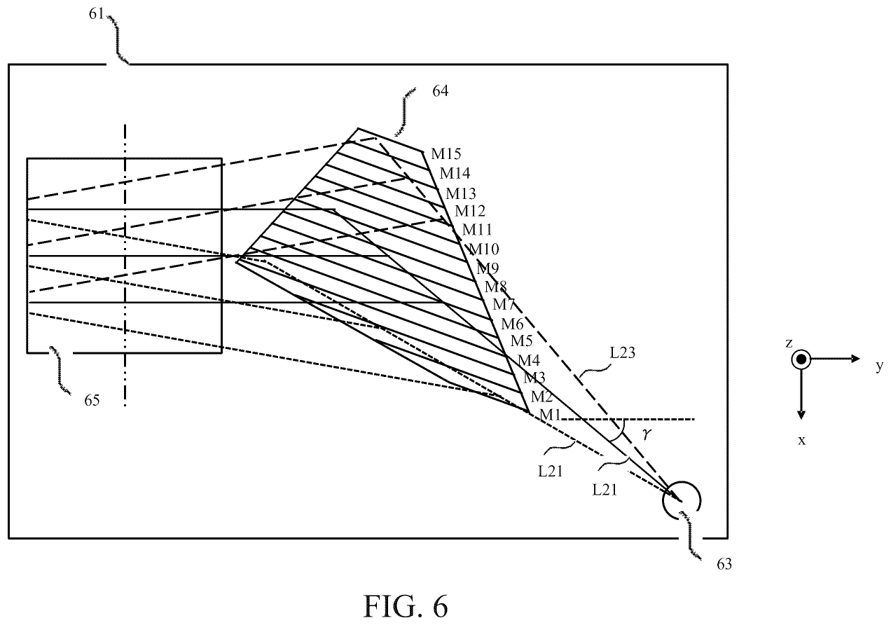

Referring now to FIG. 6, a description will be given of a light guide plate 61 according to Example 2 of the present disclosure. FIG. 6 is a configuration diagram of the light guide plate 61 according to this example. The light guide plate 61 includes an entrance portion 63, a separating portion 64 having a plurality of separating surfaces tilted at a predetermined angle in the xy section, and an emitting portion 65 having a plurality of separating surfaces tilted at a predetermined angle in the xz section. The separating portion 64 is vapor-deposited with the first to fifteenth dielectric films M1 to M15, as in Example 1. The separating portion 64 is configured to reduce unnecessary separating surfaces that do not contribute to condensing of image light on the eye box, and this example can reduce unnecessary light and improve light utilization efficiency.

### Example 3

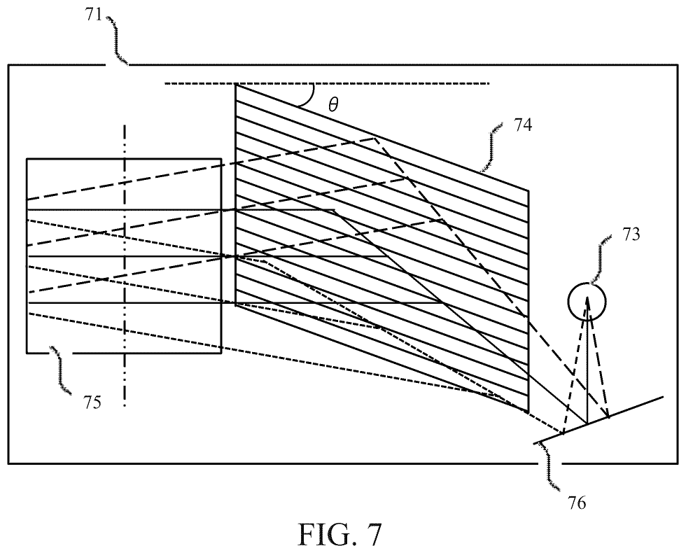

Referring now to FIG. 7, a description will be given of a light guide plate 71 according to Example 3 of the present disclosure. FIG. 7 is a configuration diagram of the light guide plate 71 according to this example. The light guide plate 71 includes an entrance portion 73, a separating portion 74 having a plurality of separating surfaces tilted at a predetermined angle in the xy section, an emitting portion 75 having a plurality of separating surfaces tilted at a predetermined angle in the xz section, and a reflective surface 76. The separating portion 74 is vapor-deposited with the first to fifteenth dielectric films M1 to M15, similarly to Example 1. By reflecting the image light from the entrance portion 73 by the reflective surface 76, the light guide plate 71 can have a reduced size.

### Numerical Example 1

| | INCIDENT ANGLE ON XY SECTION OF LIGHT RAY L32(°) | | | | | | | | | | |
|---|---|---|---|---|---|---|---|---|---|---|---|
| | 60° | 62° | 64° | 66° | 68° | 70° | 72° | 74° | 76° | 78° | 80° |
| | INCIDENT ANGLE ON FILM(°) | | | | | | | | | | |
| | 64.3° | 66.0° | 67.7° | 69.4° | 71.1° | 72.8° | 74.5° | 76.2° | 77.9° | 79.6° | 81.4° |
| M1 | 0.0% | 0.0% | 0.0% | 0.0% | 0.0% | 0.0% | 0.0% | 0.0% | 0.0% | 0.0% | 15.0% |
| M2 | 0.0% | 0.0% | 0.0% | 0.0% | 0.0% | 0.0% | 0.0% | 0.0% | 0.0% | 15.0% | 25.0% |
| M3 | 0.0% | 0.0% | 0.0% | 0.0% | 0.0% | 0.0% | 0.0% | 0.0% | 15.0% | 25.0% | 35.0% |
| M4 | 0.0% | 0.0% | 0.0% | 0.0% | 0.0% | 0.0% | 0.0% | 15.0% | 25.0% | 35.0% | 45.0% |
| M5 | 0.0% | 0.0% | 0.0% | 0.0% | 0.0% | 0.0% | 15.0% | 25.0% | 35.0% | 45.0% | 60.0% |
| M6 | 0.0% | 0.0% | 0.0% | 0.0% | 0.0% | 15.0% | 25.0% | 35.0% | 45.0% | 60.0% | |
| M7 | 0.0% | 0.0% | 0.0% | 0.0% | 15.0% | 25.0% | 35.0% | 45.0% | 60.0% | | |
| M8 | 0.0% | 0.0% | 0.0% | 15.0% | 25.0% | 35.0% | 45.0% | 60.0% | | | |
| M9 | 0.0% | 0.0% | 15.0% | 25.0% | 35.0% | 45.0% | 60.0% | | | | |
| M10 | 0.0% | 15.0% | 25.0% | 35.0% | 45.0% | 60.0% | | | | | |
| M11 | 15.0% | 25.0% | 35.0% | 45.0% | 60.0% | | | | | | |
| M12 | 25.0% | 35.0% | 45.0% | 60.0% | | | | | | | |
| M13 | 35.0% | 45.0% | 60.0% | | | | | | | | |
| M14 | 45.0% | 60.0% | | | | | | | | | |
| M15 | 60.0% | | | | | | | | | | |

### Numerical Example 2

| | INCIDENT ANGLE ON FILM(°) | | | | | | |
|---|---|---|---|---|---|---|---|
| | 50.0° | 53.3° | 56.7° | 60.0 | 63.3° | 66.7° | 70.0° |
| M21 | 0.0% | 0.0% | 0.0% | 0.0% | 0.0% | 0.0% | 16.0% |
| M22 | 0.0% | 0.0% | 0.0% | 0.0% | 0.0% | 13.0% | 28.0% |
| M23 | 0.0% | 0.0% | 0.0% | 0.0% | 11.0% | 24.0% | 41.0% |
| M24 | 0.0% | 0.0% | 0.0% | 10.0% | 21.0% | 35.0% | 55.0% |
| M25 | 0.0% | 0.0% | 9.0% | 18.0% | 30.0% | 46.0% | 72.0% |
| M26 | 0.0% | 8.0% | 16.0% | 26.0% | 40.0% | 51.0% | 79.0% |
| M27 | 8.0% | 15.0% | 23.0% | 35.0% | 53.0% | 66.0% | |
| M28 | 13.0% | 21.0% | 21.0% | 46.0% | 57.0% | | |
| M29 | 19.0% | 28.0% | 41.0% | 50.0% | | | |
| M30 | 26.0% | 37.0% | 45.0% | | | | |
| M31 | 34.0% | 41.0% | | | | | |
| M32 | 37.0% | | | | | | |

### Numerical Example 3

| | INCIDENT ANGLE ON XY SECTION OF LIGHT RAY L32(°) | | | | | | | | | | |
|---|---|---|---|---|---|---|---|---|---|---|---|
| | 60° | 62° | 64° | 66° | 68° | 70° | 72° | 74° | 76° | 78° | 80° |
| | INCIDENT ANGLE ON FILM(°) | | | | | | | | | | |
| | 64.3° | 66.0° | 67.7° | 69.4° | 71.1° | 72.8° | 74.5° | 76.2° | 77.9° | 79.6° | 81.4° |
| M1 | 0.0% | 0.0% | 0.0% | 0.0% | 0.0% | 0.0% | 0.0% | 0.0% | 0.0% | 20.0% | 20.0% |
| M2 | 0.0% | 0.0% | 0.0% | 0.0% | 0.0% | 0.0% | 0.0% | 0.0% | 0.0% | 20.0% | 20.0% |
| M3 | 0.0% | 0.0% | 0.0% | 0.0% | 0.0% | 0.0% | 0.0% | 20.0% | 20.0% | 35.0% | 35.0% |
| M4 | 0.0% | 0.0% | 0.0% | 0.0% | 0.0% | 0.0% | 0.0% | 20.0% | 20.0% | 35.0% | 35.0% |
| M5 | 0.0% | 0.0% | 0.0% | 0.0% | 0.0% | 20.0% | 20.0% | 35.0% | 35.0% | 50.0% | 50.0% |
| M6 | 0.0% | 0.0% | 0.0% | 0.0% | 0.0% | 20.0% | 20.0% | 35.0% | 35.0% | 50.0% | 50.0% |
| M7 | 0.0% | 0.0% | 0.0% | 20.0% | 20.0% | 35.0% | 35.0% | 50.0% | 50.0% | | |
| M8 | 0.0% | 0.0% | 0.0% | 20.0% | 20.0% | 35.0% | 35.0% | 50.0% | 50.0% | | |
| M9 | 0.0% | 20.0% | 20.0% | 35.0% | 35.0% | 50.0% | 50.0% | | | | |
| M10 | 0.0% | 20.0% | 20.0% | 35.0% | 35.0% | 50.0% | 50.0% | | | | |
| M11 | 20.0% | 35.0% | 35.0% | 50.0% | 50.0% | | | | | | |
| M12 | 20.0% | 35.0% | 35.0% | 50.0% | 50.0% | | | | | | |
| M13 | 35.0% | 50.0% | 50.0% | | | | | | | | |
| M14 | 35.0% | 50.0% | 50.0% | | | | | | | | |
| M15 | 50.0% | | | | | | | | | | |

### Numerical Example 4

| | INCIDENT ANGLE ON XY SECTION OF LIGHT RAY L32(°) | | | | | | | | | | |
|---|---|---|---|---|---|---|---|---|---|---|---|
| | 60° | 62° | 64° | 66° | 68° | 70° | 72° | 74° | 76° | 78° | 80° |
| | INCIDENT ANGLE ON FILM(°) | | | | | | | | | | |
| | 64.3° | 66.0° | 67.7° | 69.4° | 71.1° | 72.8° | 74.5° | 76.2° | 77.9° | 79.6° | 81.4° |
| M1 | 0.0% | 0.0% | 0.0% | 0.0% | 0.0% | 0.0% | 0.0% | 0.0% | 0.0% | 0.0% | 17.0% |
| M2 | 0.0% | 0.0% | 0.0% | 0.0% | 0.0% | 0.0% | 0.0% | 0.0% | 0.0% | 17.0% | 24.0% |
| M3 | 0.0% | 0.0% | 0.0% | 0.0% | 0.0% | 0.0% | 0.0% | 0.0% | 17.0% | 24.0% | 32.0% |
| M4 | 0.0% | 0.0% | 0.0% | 0.0% | 0.0% | 0.0% | 0.0% | 17.0% | 24.0% | 32.0% | 46.0% |
| M5 | 0.0% | 0.0% | 0.0% | 0.0% | 0.0% | 0.0% | 17.0% | 24.0% | 32.0% | 46.0% | 75.0% |
| M6 | 0.0% | 0.0% | 0.0% | 0.0% | 0.0% | 17.0% | 24.0% | 32.0% | 46.0% | 75.0% | |
| M7 | 0.0% | 0.0% | 0.0% | 0.0% | 17.0% | 24.0% | 32.0% | 46.0% | 75.0% | | |
| M8 | 0.0% | 0.0% | 0.0% | 17.0% | 24.0% | 32.0% | 46.0% | 75.0% | | | |
| M9 | 0.0% | 0.0% | 17.0% | 24.0% | 32.0% | 46.0% | 75.0% | | | | |
| M10 | 0.0% | 17.0% | 24.0% | 32.0% | 46.0% | 75.0% | | | | | |
| M11 | 17.0% | 24.0% | 32.0% | 46.0% | 75.0% | | | | | | |
| M12 | 24.0% | 32.0% | 46.0% | 75.0% | | | | | | | |
| M13 | 32.0% | 46.0% | 75.0% | | | | | | | | |
| M14 | 46.0% | 75.0% | | | | | | | | | |
| M15 | 75.0% | | | | | | | | | | |

Each example can provide a light guide element and an image display apparatus with improved light utilization efficiency. Also, each example can improve the luminance distribution and reduce the light-amount unevenness.

While the disclosure has described example embodiments, it is to be understood that the disclosure is not limited to the example embodiments. The scope of the following claims is to be accorded the broadest interpretation so as to encompass all such modifications and equivalent structures and functions.

This application claims priority to Japanese Patent Application No. 2024-082361, which was filed on May 21, 2024, and which is hereby incorporated by reference herein in its entirety.

What is claimed is:

1. A light guide element configured to guide light from a display element to a pupil, the light guide element comprising:
an entrance portion which the light is to enter;
a separating portion configured to separate the light in a first direction; and
an emitting portion configured to emit the light toward the pupil,
wherein the separating portion has a plurality of separating surfaces with spectral reflectances different from each other, and
wherein the plurality of separating surfaces include a dielectric film including a plurality of layers.

2. The light guide element according to claim 1, wherein the following inequality is satisfied:
$$5 \leq θ \leq 35$$
where θ is an angle [°] of the plurality of separating surfaces relative to the first direction.

3. The light guide element according to claim 1, wherein the following inequalities are satisfied:
$$n H \geq 2 \text{.00}$$
$$nL \leq 1.60$$
where nH is a maximum value of refractive indices of the plurality of separating surfaces for light of a dominant wavelength, and nL is a minimum value of the refractive indices of the plurality of separating surfaces for the light of the dominant wavelength.

4. The light guide element according to claim 1, wherein the plurality of separating surfaces include at least one of a separating surface having a refractive index for light of a dominant wavelength of 2.0 or more and a thickness of the dielectric film of 100 nm or more, and a separating surface having a refractive index for light of a dominant wavelength of 1.6 or less and a thickness of the dielectric film of 100 nm or more.

5. The light guide element according to claim 1, wherein the emitting portion has a plurality of emitting surfaces with spectral reflectances different from each other.

6. A light guide element configured to guide light from a display element to a pupil, the light guide element comprising:
an entrance portion which the light is to enter;
a separating portion configured to separate the light in a first direction; and
an emitting portion configured to emit the light toward the pupil,
wherein the separating portion has a plurality of separating surfaces with spectral reflectances different from each other, and
wherein the plurality of separating surfaces includes at least one separating surface that satisfies the following inequality:
$$0.7 \leq R e ( α , n , P ) / R e ( α , n , S ) \leq 1.6$$
where regarding an n-th separating surface counted from the entrance portion among the plurality of separating surfaces, Re(α, n, S) is a reflectance [%] to S-polarized light in light with a dominant wavelength while a is an incident angle [°] of a principal ray, and Re(α, n, P) is a reflectance [%] to P-polarized light in light with a dominant wavelength while a is an incident angle [°] of a principal ray.

7. The light guide element according to claim 6, wherein the emitting portion has a plurality of emitting surfaces with spectral reflectances different from each other, and
wherein the plurality of emitting surfaces include at least one emitting surface that satisfies the following inequality:
$$R o ( β , m , P ) / Ro ( β , m , S ) \leq 0.3$$
where regarding an m-th emitting surface counted from the entrance portion among the plurality of emitting surfaces, Ro(β, m, S) is a reflectance [%] to S-polarized light in light of a dominant wavelength while β is an incident angle [°] of a principal ray, and Ro(β, m, P) is a reflectance [%] to P-polarized light in light of a dominant wavelength while β is an incident angle [°] of a principal ray.

8. The light guide element according to claim 6, wherein where nG is a refractive index of the light guide element, and ωV is a field angle (°) on a section that has the first direction,
a first separating surface satisfies the following inequality:
$$R e ( α + ω V / nG , 1 , P ) > 1.1 \times R e ( α , 1 , P ) ,$$
and
the plurality of separating surfaces include at least one separating surface that satisfies the following inequality:
$$R e ( α , n , P ) > 1.1 \times R e ( α - ω V / nG , n , P ) .$$

9. The light guide element according to claim 6, wherein the separating surfaces include at least one separating surface that satisfies the following inequalities:
$$R e ( α , n , P ) \leq 10.$$
$$R e ( α , n , S ) \leq 10.0 .$$

10. The light guide element according to claim 1, wherein the following inequality is satisfied:
$$R min / R max \leq 0.20$$
where Rmax is a maximum reflectance of an average of a reflectance to P-polarized light and a reflectance to S-polarized light of the separating portion in a principal ray of a dominant wavelength, and Rmin is a minimum reflectance of the average of the reflectance to the P-polarized light and the reflectance to the S-polarized light of the separating portion in the principal ray of the dominant wavelength.

11. The light guide element according to claim 1, further comprising a first surface and a second surface that are parallel to each other,
wherein the emitting portion has a first emitting surface, a second emitting surface, and a third emitting surface, each of which is not parallel to the first surface,
wherein the first emitting surface, the second emitting surface, and the third emitting surface have spectral reflectances different from each other, and
wherein the following inequalities are satisfied:
$${θ}_{1} + 5 < {θ}_{2} < {θ}_{3} - 5$$
$$Rs {1}_{21} > Rs {1}_{22} > Rs {1}_{23}$$
$$Rs {1}_{31} < Rs {1}_{32}$$
$$Rs {1}_{33} < Rs {1}_{32}$$
where p is an order of each of the first emitting surface, the second emitting surface, and the third emitting surface, φₚ is an angle [°] of a p-th emitting surface relative to a normal to the first surface, θ_{q} is an incident angle [°] of a q-th light ray (where q is a natural number) incident on the first surface, and Rs1_{pq} is a reflectance (%) of the p-th emitting surface relative to light of a dominant wavelength having an incident angle [°] of 90−θ_{q}+φₚ.

12. A display apparatus comprising:
the light guide element according to claim 1; and
the display element.

13. A display apparatus comprising:
a display element; and
a light guide element configured to guide light from a display element to a pupil,
wherein the light guide element includes:
an entrance portion which the light is to enter,
a separating portion configured to separate the light in a first direction, and
an emitting portion configured to emit the light toward the pupil,
wherein the following inequality is satisfied:
$$Ly / Li \geq 0.40$$
where Li is an illuminance [lx] of light of a dominant wavelength incident on the entrance portion, and Ly is a light amount [lx] emitted to a region of an exit pupil in the first direction.

14. The display apparatus according to claim 13, wherein the separating portion has a plurality of separating surfaces with spectral reflectances different from each other.

15. The display apparatus according to claim 14, wherein the following inequality is satisfied:
$$5 \leq θ \leq 35$$
where θ is an angle [°] of the plurality of separating surfaces relative to the first direction.

16. The display apparatus according to claim 15, wherein the following inequality is satisfied:
$$\vert Ly 1 - Ly 2 \vert / ( Ly 1 + Ly 2 ) \geq 0.5$$
where Ly1 is an illuminance [lx] of polarized light in the first direction emitted to the region of the exit pupil in the first direction, and Ly2 is illuminance [lx] of polarized light in a second direction.

17. The display apparatus according to claim 13, wherein the following inequalities are satisfied:
$$Ey 1 / Ei 1 \geq 0.4$$
$$Ey 2 / Ei 2 \geq 0.40$$
where Ei1 is a light amount [W/mm²] of a first wavelength as a peak wavelength in a red band incident on the entrance portion, Ei2 is a light amount [W/mm²] of a second wavelength as a peak wavelength in a green band incident on the entrance portion, Ey1 is a light amount [W/mm²] of the first wavelength emitted to the region of the exit pupil in the first direction, and Ey2 is a light amount of the second wavelength emitted to the region of the exit pupil in the first direction.

18. The display apparatus according to claim 13, wherein the following inequality is satisfied:
$$Lx / Li \geq 0.40$$
where Lx is an illuminance [lx] emitted to the region of the exit pupil in a second direction perpendicular to the first direction.

19. The display apparatus according to claim 17, wherein the following inequalities are satisfied:
$$Ex 1 / Ei 1 \geq 0.4$$
$$Ex 2 / Ei 2 \geq 0.40$$
where Ex1 is a light amount [W/mm²] of the first wavelength emitted to the region of the exit pupil in a second direction perpendicular to the first direction, and Ex2 is a light amount [W/mm²] of the second wavelength.

20. The display apparatus according to claim 13, wherein the following inequality is satisfied:
$$0. < W / R < 0.03$$
where R is a central wavelength [nm] of at least one spectrum of a light beam emitted from a light source, and W is a full width at half maximum [nm] of the spectrum.
